(19) United States
(12) Patent Application Publication
(10) Pub. No.: US 2005/0182504 A1
(43) Pub. Date: Aug. 18, 2005

(54) Apparatus to produce karaoke accompaniment

(76) Inventor: James Lee Bailey, Salt Lake City, UT (US)

Correspondence Address: TRASK BRITT, P.O. BOX 2550, SALT LAKE CITY, UT, 84110, US

(21) Appl. No.: 10/782,338

(22) Filed: Feb. 18, 2004

(51) Int. Cl. G06F 17/00

(52) U.S. Cl. 700/94; 381/119

(57) ABSTRACT

A process and apparatus to convert, an input musical signal, including an original vocalist and musical accompaniment, into accompaniment for a Karaoke singer. The component of the input musical signal corresponding to the original vocalist is suppressed, by filtering or digital processing, to reduce audibility of that vocalist. The resulting modified musical signal can be recorded for future playback. A user's voice also can be added to the modified musical signal, to replace the original vocalist, with the corresponding output of the apparatus being played audibly in real-time, recorded for future playback, or both. In certain embodiments, circuitry can be included to perform effects on a user's vocal input, such as pitch control, reverb, and echo.

### TECHNICAL FIELD

The present invention relates to devices operable to provide musical accompaniment for a Karaoke singer. In particular, the invention provides an apparatus to modify commercially available audio recordings or sources, such as music CD's and broadcast radio signals, to reduce an audible presence, in an output signal applied to a playback device, of an original lead singer's voice.

### BACKGROUND

Karaoke is a term used to describe a singer that sings along with a prerecorded musical accompaniment, typically for a poplar song. The prerecorded musical accompaniment typically includes instrumental sounds, and may include back-up vocals, but the original lead singer's voice is removed from the recording. Recorded Karaoke accompaniment generally is commercially available only for selected popular songs. For example, certain selected songs are commercially available compiled on CD+G prerecorded media. However, such Karaoke accompaniment is relatively expensive compared to similar (but unmodified) original music recordings typically present in a user's personal music collection. Furthermore, the commercially available selection many times will not include a potential Karaoke singer's desired song. Obtaining a Karaoke accompaniment for a single desired song may require purchase of a compiled selection including several additional undesired songs. Furthermore, the available prerecorded accompaniment may be from a slightly different rendition or version of the desired song, compared to a familiar version.

It would be an improvement in the art to provide an apparatus operable to create Karaoke accompaniment from virtually any song present in a user's personal music collection. A further enhancement would be to embody that apparatus in a convenient and portable form factor, including a hand-held form factor. It would be an additional improvement if the apparatus could be enhanced by add-on portions to provide additional signal processing capabilities, such as reverb, echo, and pitch control. Certain add-on portions to that apparatus operable to provide recording capabilities, digital signal processing capabilities, to provide a plurality of headphone outputs, or to permit Karaoke inputs from a plurality of singers, would also constitute desirable improvements over the currently available art.

### BRIEF SUMMARY OF THE INVENTION

In broad terms, the invention can be characterized as a Karaoke ripper. A preferred embodiment of the invention receives an analog input signal from a prerecorded music source, such as a CD, or FM stereo broadcast, and outputs an accompaniment for a Karaoke singer having reduced audibility of the original lead singer's voice.

One analog Karaoke ripper includes a first connector adapted to receive an analog music signal as a first apparatus input signal. A second connector is arranged to receive a second apparatus input signal from a user's first microphone. A first circuitry compares left channel and right channel information carried by the first apparatus input signal and extracts center channel information from the left channel and the right channel to form a first modified left channel, a center channel, and a first modified right channel. The first circuitry processes the center channel effective to reduce audibility of the original lead singer's voice in a resulting processed signal. The first circuitry also mixes the second apparatus input signal with the processed signal and the first modified left channel to form a second modified left channel output. Similarly, it mixes the second apparatus input signal with the processed signal and the first modified right channel to form a second modified right channel output. An electrical power source, such as a nine volt battery or extension cord from a utility socket, is used to energize the circuitry. A third connector is used to transmit an apparatus output signal, including the second modified left channel output and the second modified right channel output, to a playback device. Desirably, a volume control is included to effect an audible volume when the apparatus output signal is applied to a playback device, such as a set of headphones. In the currently preferred Karaoke ripper, the first circuitry includes an analog vocal fader circuit.

A Karaoke ripper desirably includes a multiway switch to determine the mode of operation of the device. An off position is operable electrically to decouple the power source from the first circuitry. A play-through position desirably places the first circuitry into a second configuration operable to permit playback of an apparatus output signal including the first input signal. A first vocal fade position desirably places the first circuitry into an arrangement to produce Karaoke accompaniment. A second vocal fade position can be included to configure the ripper to produce a first output with an unmodified playback from the music source for audible perception by the user, as well as a second output for Karaoke musical accompaniment.

The invention may alternatively operate substantially in the digital realm to process a first digital music signal that includes information including at least the sound from one vocalist and musical accompaniment. Such a digital-capable embodiment typically includes a source input receptor operable to receive the first digital signal, and a user input receptor operable to receive a user's first microphone input. A first analog-to-digital converter is arranged to operate on the first microphone input and to output a second digital signal. A first digital processor is adapted in a circuit to operate on the first digital signal to reduce audibility of the vocalist and to output a first-modified digital signal. A second digital processor is arranged in-circuit as a mixer to combine the second digital signal and the first-modified digital signal effective to form a left-out channel, and a right-out channel. A digital-to-analog converter is adapted to operate on the left-out and the right-out channels to form a stereo analog output signal from the apparatus. Desirably, a volume control is provided operable on the stereo analog output signal to effect an audible volume when the stereo analog output signal is applied to a playback device. Sometimes, such a device includes a user operable control effective to select a notch frequency range in which reduction of audibility of the original lead singer is performed by the first digital processor. That user operable control can adjust the first digital processor to select an amount of reduction in audibility of the vocalist.

The invention can be embodied for digital processing of a first analog signal input that carries information including at least the sound from one vocalist and musical accompaniment in a left channel and a right channel. Typically such a device includes a source input receptor operable to receive the first analog signal, and a user input receptor operable to receive a user's analog input from a microphone. A first analog-to-digital converter is arranged to operate on the first analog signal and to output a first digital signal. A first signal processor is arranged to operate on the first digital signal effective to output information corresponding at least to left-in, right-in, and center-in channels. A second analog-to-digital converter is arranged to operate on the user's analog input and to output a second digital signal. A second signal processor, operable as a reducer, is arranged to operate on at least a portion of the center-in channel to reduce audibility of the vocalist and to output a center-out channel. A third signal processor is arranged in-circuit as a mixer to combine the second digital signal, the center-out channel, and the left-in channel to form a left-out channel. Similarly, it combines the second digital signal, the center-out channel, and the right-in channel to form a right-out channel. A digital-to-analog converter is arranged to operate on the left-out and right-out channels to form a stereo analog output signal for audible playback or recording. The first signal processor can be a digital signal processor adapted to output a signal in a digital music format, such as WMA or MP3. Desirably, a Karaoke ripping apparatus is embodied in a hand-held device for portability and convenience to a user.

Certain embodiments of the Karaoke ripping invention include one or more expansion slot adapted to receive an add-on card, and one or more add-on cards. Add-on cards can provide extra capabilities and features to enhance operation of the inventive Karaoke ripper. One add-on card includes a digital signal processor structured and arranged to reduce audibility of the singer's voice in the digital realm. Another add-on card is effective to produce vocal effects in a Karaoke output. An alternate add-on card includes a nonvolatile memory adapted for record and playback of an output signal. In one arrangement, an add-on card carries a socket in which to receive a commercially available digital memory device. One add-on card can provide a plurality of microphone inputs and/or a plurality of headphone outputs. Still another feature that can be provided by an add-on card is a display device operable to provide a user with visible information, such as lyrics, timing, artist and track data, and the like. Such a display can be an LCD screen, a laser and mirror for projecting a visible display onto a wall. An add-on card may provide a connector for attachment to a remote TV-type monitor or computer.

The invention provides a method for converting an output from a conventional multichannel music source, which output carries information including an original lead singer's voice and musical accompaniment, into substantially real-time musical accompaniment for a Karaoke singer, the process including the steps of: a) providing a Karaoke ripping device; b) inputting the output from a music source as a first input signal to the device; c) comparing left channel and right channel information carried by the first input signal to determine a center channel; d) extracting the center channel from the left channel and the right channel to form a center channel, a modified left channel, and a modified right channel; e) processing the center channel to reduce audible presence of the original singer's voice in a processed signal; and f) outputting a combination of the modified left channel, the modified right channel, and the processed signal as an output signal.

### BRIEF DESCRIPTION OF THE SEVERAL VIEWS OF THE DRAWINGS

In the drawings, which illustrate what are currently considered to be the best modes for carrying out the invention:

FIG. 1 is a view from below and in perspective of the front-side of a currently preferred hand-held embodiment of the invention, and including a plurality of alternative add-on cards in an exploded assembly format;

FIG. 2 is a view from above and in perspective of the back-side of the embodiment illustrated in FIG. 1;

FIG. 3 is a block diagram schematic illustrating operation of a Karaoke device;

FIG. 4 is an overview of an electrical schematic for a motherboard useful in the device illustrated in FIG. 1;

FIG. 5 is a detailed illustration of that portion of the schematic of FIG. 4 designated by the letter A;

FIG. 6 is a detailed illustration of that portion of the schematic of FIG. 4 designated by the letter B;

FIG. 7 is a detailed illustration of that portion of the schematic of FIG. 4 designated by the letter C;

FIG. 8 is a detailed illustration of that portion of the schematic of FIG. 4 designated by the letter D;

FIG. 9 is a table listing inputs for, and outputs from, an expansion slot connector disposed in a preferred Karaoke circuit arrangement;

FIG. 10 is a detailed illustration of that portion of the schematic of FIG. 4 designated by the letter E;

FIG. 11 illustrates an arrangement to form a vocal effects add-on card;

FIG. 12 illustrates an arrangement to form an add-on card that provides additional microphone inputs and headphone outputs;

FIG. 13 illustrates an arrangement to form a record/playback add-on card; and

FIG. 14 illustrates an arrangement to form a digital processing add-on card.

### DETAILED DESCRIPTION OF THE ILLUSTRATED EMBODIMENTS

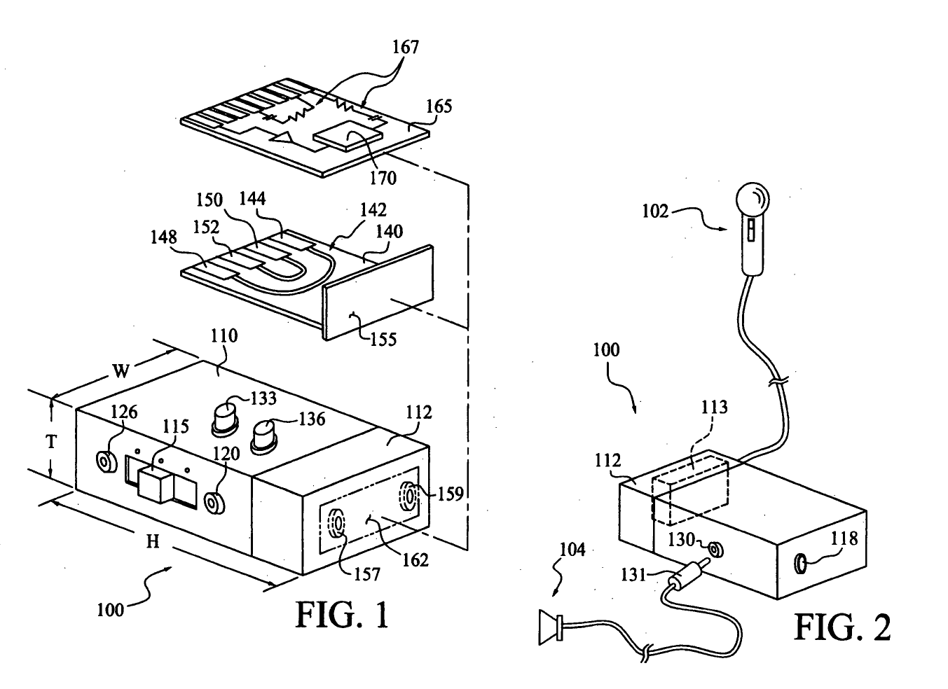

With reference to FIGS. 1 and 2, it currently is preferred to manufacture a Karaoke device, structured according to principles of the present invention, as a hand-held apparatus, generally indicated at 100, used in combination with one or more input device 102 and playback device 104. Typically, a microphone 102 is used as an input device, and a speaker 104, or headphone set is used as a playback device. One relatively larger-size hand-held apparatus that can accommodate a Karaoke device in accordance with the invention includes a laptop computer. However, as illustrated in FIG. 1, it is preferred for a Karaoke device 100 to have maximum height H, width W, and thickness T, of about 6×4×2 inches, respectively. A Karaoke device 100 desirably is sized to fit into a shirt pocket, like a package of cigarettes, or deck of cards. Certain Karaoke devices, structured according to principles of the present invention, may be incorporated into commercially available digital music players, such as MP3 players, substantially as a circuit board enhancement. In alternative embodiments of the invention, a Karaoke device may be embodied in a device encompassing a larger size envelope, such as in a desktop computer.

In detail, illustrated Karaoke device 100 includes a housing 110, sized to hold a motherboard carrying first circuitry adapted to reduce audible presence of a prerecorded lead singer's voice in a Karaoke accompaniment. A removable bottom 112 provides convenient access to an optional internally stored nine volt battery 113 electric power source which is effective to operate the first circuitry in a portable configuration. It also is within contemplation to provide a plug-in transformer adapted to tap into a 120-volt wall outlet as a source of tethered power for the device 100.

The illustrated embodiment 100 includes a multiway switch 115 arranged in-circuit at a first position to decouple the battery from energizing the first circuitry. At a second position, switch 115 places circuitry of the illustrated embodiment 100 into a “play-through” configuration that allows playback of the input signal. Switch 115 also may be adjusted to a third position to place the first circuitry into a configuration to perform a vocal fade operation on a lead singer's voice of an input musical signal.

With reference to FIG. 2, it currently is preferred to provide a display device, such as LED 118, to indicate the operational status, or electrical configuration, of device 100. In one embodiment of device 100, LED 118 is a bicolor LED, showing a green visible output when switch 115 is in the second position, and a red visible output when switch 115 is in the third position. Additional positions, and indicator lamps or colors, may be used in combination with a switch 115 to provide additional configurations of the first circuitry, and/or to enable additional features and operations.

It is within contemplation for an alternative display device to show the text of a song being processed by the device 100. Additionally, the display device may be adapted to indicate timing sequences, e.g. from the original start-up of a CD, or incremental timing marks in a digital format. Display devices within contemplation include LCD screens, video output from device 100 to a separate display device such as a TV-type monitor, and a light emitting device operable to display information on a secondary object, such as a wall. One such light emitting device uses a mirror to manipulate a projected visible beam from a laser, or other light emitting device.

Making reference again to FIG. 1, a connector 120 typically is provided to accept a musical input to device 100 from a multichannel source, such as a CD, FM or AM stereo broadcast signal, output from a digitally formatted (including MP3, WMA, and other digital music formats) music player, or other analog signal having at least left and right channel information. Illustrated connector 120 is a conventional 3.5 mm female jack adapted to receive a cooperating male plug end. Certain embodiments of a Karaoke device within the ambit of the invention can acquire a musical input signal by way of an internal connector. One example of such an arrangement can accept a musical input from an internal hard drive, or nonvolatile memory.

An additional connector 126 typically is provided to receive an input from a microphone, such as analog microphone 102 shown in FIG. 2. As illustrated, microphone 102 may include a remote switch operable to interrupt its output signal, if, and when desired.

An output signal from device 100 may be acquired, for input to a playback device such as speaker or headphone set 104, through connector 130 (see FIG. 2). While any connector operable to pass an electrical signal may be used, including banana jacks or even pairs of screw terminals, it is preferred for connector 130 also to be a small-sized plug receptacle, such as the commercially available 3.5 mm audio type. Connector 130 desirably is adapted to receive a cooperating male plug end 131 operably to communicate a signal including left and right channels, for a stereo output.

In the illustrated embodiment 100, the strength of an output signal is used to regulate a audible volume from an output signal applied through a playback device 104. A digital volume control is used in the illustrated device 100 for convenience, although other types of volume controllers are operable, including roller knobs and dials. The volume control user interface illustrated in FIG. 1 includes an “up” button 133 and a “down” button 136, the functions of which are self-explanatory. Placement or location of the various controls and inputs on a device 100 may be determined by ergonomic factors, and/or convenience for manufacturing.

A currently preferred motherboard used in device 100 is arranged to operate on an analog musical input. The motherboard desirably is configured to accept daughter cards, or add-on cards, to provide additional features and options. A convenient arrangement for such add-on cards provides an expansion slot on the motherboard arranged in-circuit to interrupt one or more signals passing through the first circuitry. The expansion slot provides a way to insert additional signals, or additional circuitry, into the first circuitry.

Illustrated add-on card 140 is configured as a placeholder, to form a jumper path, generally indicated at 142, between electrical contacts 144 and 148. A second jumper path is illustrated between electrical contacts 150 and 152. The electrical contacts 144, 148, 150, 152 are arranged to cooperate with corresponding contacts of the expansion slot or socket in the first circuitry. Electrical contacts, such as contact 150, can be placed on one or more surfaces of a daughter board to provide a larger number of contacts, and to permit placement of circuit elements on both sides of the board substrate. Any convenient number of contacts may be provided in an expansion slot and daughter card. In a currently preferred embodiment, eight pairs of contacts are provided in an expansion slot and on corresponding add-on cards. Such contacts are arranged eight to a side at one end of each add-on card.

Add-on card 140 is configured as a placeholder, and typically would be provided in a device 100 as a standard model. A blank end surface 155 is included to form a portion of bottom 112. To expand the capabilities of device 100, a user can exchange card 140 for a different card. One alternative card is illustrated in FIG. 1 as being installed in device 100, and includes additional connectors 157 and 159. End surface 162 carries the connectors 157 and 159, and replaces blank end surface 155. Depending upon the function of the replacement card, connectors 157 and 159 could provide additional microphone inputs, additional playback device outputs, or a mix of each. A plurality of such additional connectors can be provided in alternative add-on cards to enhance functionality of device 100.

Add-on card 165 is structured for reception within a bottom 112 that forms an enclosing container when placed on a housing 110. Card 165 can also be structurally incorporated into such a bottom 112 as a cantilevered appendage, if desired (not illustrated). Card 165 is arranged to carry additional second circuitry, generally indicated at 167, operable to provide enhancements to the device 100. Second circuitry 167 can include desired arrangements of traditional analog circuit elements, nonvolatile memory devices, and one or more digital processor 170.

It is within contemplation for an add-on card to be structured to provide vocal effects, such as pitch control, echo, and reverb. Add-on cards can provide inputs and/or outputs to enable a plurality of singers or listeners. An add-on card can also provide storage for a Karaoke output, or to record any other output from device 100, such as the musical input subsequent to reducing the vocal presence of the original lead singer's voice. One add-on card within contemplation provides a digital signal processor arranged to rip or read MP3 s and reduce the audible presence of a lead singer by digital manipulation of the digitally encoded data. Of course, such capabilities can also be incorporated directly into a motherboard.

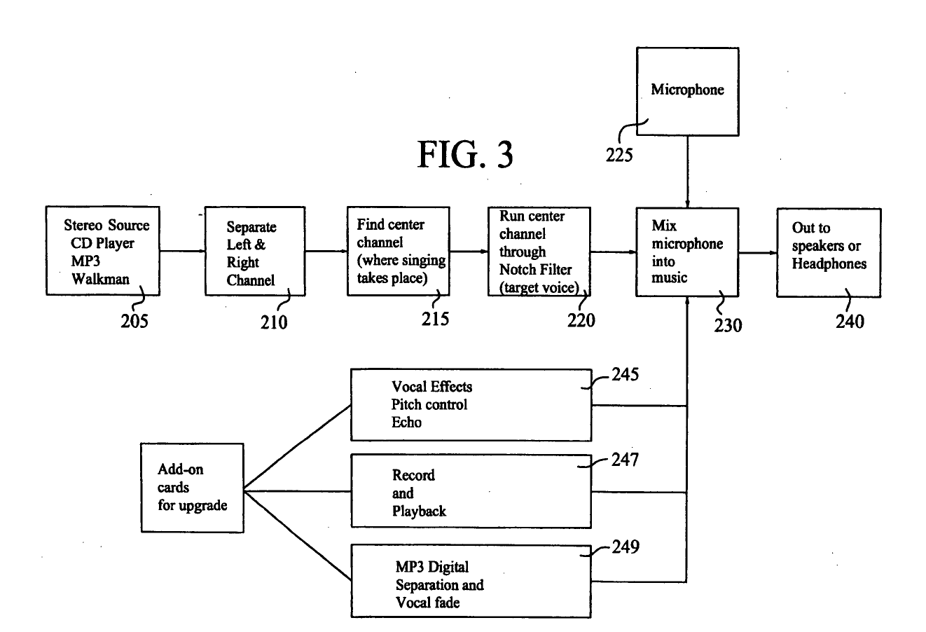

FIG. 3 illustrates a process, generally indicated at 200, for creating a Karaoke accompaniment according to the present invention. A stereo signal or source 205 is applied as an input to a processing circuit. Left and right channel information is compared at 210 to determine a center channel at 215, which is removed from the input left and right channels to form first modified left and right channels, and a center channel. The center channel is passed through a notch filter at 220 to reduce the audible presence of a lead singer's voice in the resulting modified center channel information. One or more microphone inputs 225 is mixed into the modified center channel signal, and the resulting signal is mixed at 230 with the first modified left and right channel signals to form an output signal including left and right output channels. The left and right output channels are applied to a playback device at 240.

One or more optional add-on cards 245, 247, or 249, can be inserted in-circuit to add additional features and capabilities. Card 245 carries circuitry adapted to provide vocal effects, such as amount of reverberation, pitch control, and echo in an output from the processing circuit. Card 247 exemplifies providing record and playback of an output signal from the processing circuit. Any signal, including the input signal, the modified signal having a reduced audible presence of the original lead singer, and the Karaoke output including the user's voice as a replacement lead singer, can be captured by a memory device included on, or accessed by, card 247 for future playback. It is within contemplation for a card 247 to provide one or more connectors, such as a USB, serial, or firewire connector, to access a personal computer and/or hard drive, or other storage medium. Card 247 can include a socket to permit changing an amount of on-board memory, or to exchange a storage device to record additional output, or to permit playback using the storage device in a different playback device.

Card 249 illustrates one arrangement operable to perform digital manipulation on the data forming a center channel, or other channel having the original lead singer's voice. It should be noted that a digital music input for a Karaoke device 100 can be a pre-recorded digital feed in a conventional music format, or an analog signal converted by an analog-to-digital (A/D) converter. Therefore, various preferred embodiments of the invention are adapted to receive a digital music input, and to employ digital processing to remove an original lead singer's voice, or to cause vocal effects.

It is recognized that the digital vocal fading operation enabled on card 249 can be performed by a digital processor, which may be included in an MP3 ripping device, such as a personal computer. The digital processing functionality (generally including one or more of: vocal fading, mixing, and voice effects) of card 249 can essentially be included in such a device as a product enhancement, turning that device into a Karaoke device 100. The processor of such a device can be programmed in software to manipulate the digital music signal as desired to produce a digital output. That digital output typically is converted by a digital-to-analog (D/A) converter for playback through some sort of playback device. Of course, the digital output can be recorded for future playback as well.

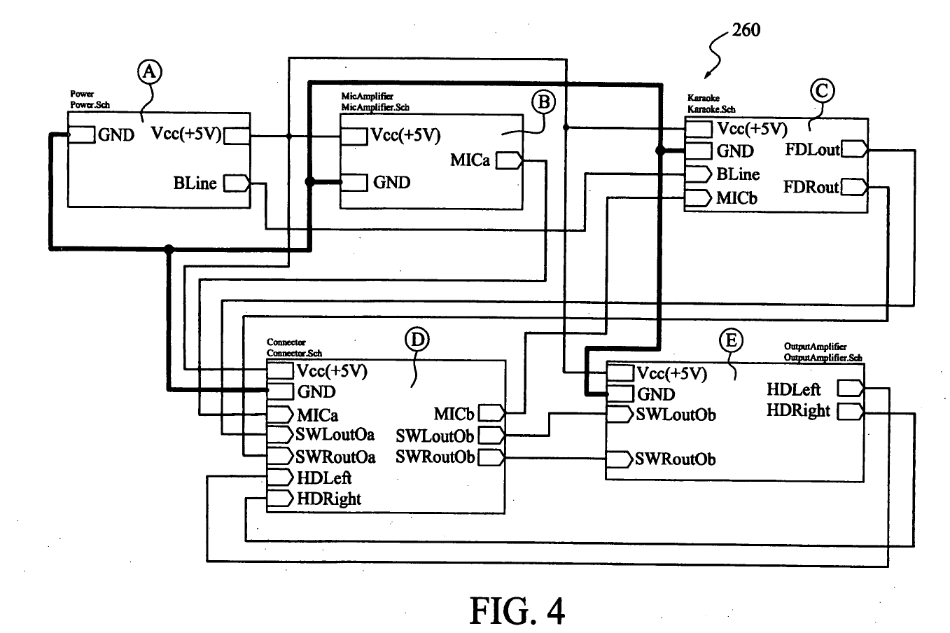

FIG. 4 illustrates an overview of an electrical schematic for a first circuitry, generally indicated at 260, operable as a preferred motherboard layout of a Karaoke device 100. Such first circuitry 260 desirably is included on a motherboard carried internal to housing 110 and bottom cap 112 of device 100. The first circuitry 260 is grouped into five convenient areas, or groupings, denoted by the capital letters A-E. Circuit portion A includes the power supply and mode/power switch; portion B includes microphone input; portion C includes a main analog vocal fader circuit; portion D includes an optional modular connector; and portion E illustrates an output arrangement.

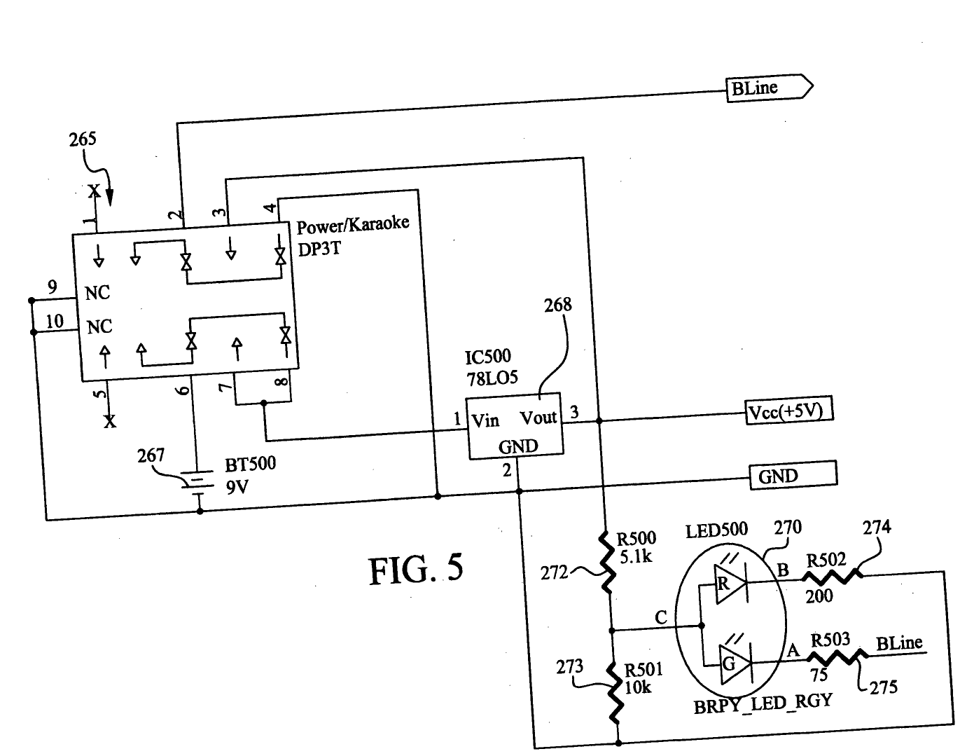

A detailed electrical schematic for circuit portion A is illustrated in FIG. 5. A switch, generally indicated at 265, is disposed in-circuit effective to decouple power source 267 from energizing circuitry 260. The illustrated switch 265 is a double-pole-triple-throw switch, although other arrangements are also operable. Switch 265 also functions to place first circuitry 260 into different configurations that are operable to perform different functions. As illustrated, pins 9 and 10 of the switch 265 are soldered to ground in combination with pin 4 to provide a rugged mechanical mounting of the switch effective to resist displacement of switch 265 when a user operates that switch.

Power source 267 desirably is a portable battery, such as a ubiquitous nine volt battery, to provide portability in a device 100. However, the power source 267 can also be, or optionally include, an arrangement operable to extract electrical power from a residential utility outlet. A regulator chip 268 can be included to maintain the voltage (designated Vcc) at a constant level, within the capabilities of the power source 267. In the preferred embodiment, the voltage Vcc is maintained at 5 volts until the nine volt battery 267 is depleted below 5 volts.

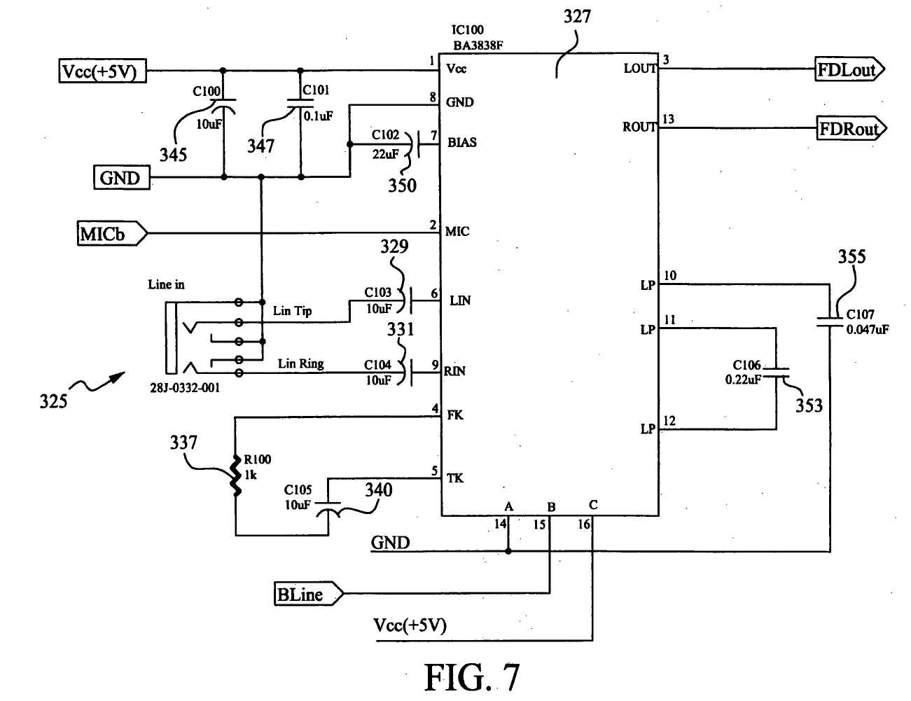

A display device, such as LED 270, typically is included to indicate the current settings or operational mode of a device 100. Illustrated LED 270 is a bicolor LED arranged in-circuit to display a red output when the device 100 is configured for “play-through” mode, and a green output to indicate the device 100 is in “vocal fader on” mode. Resistors 272 through 275 are sized and arranged in-circuit to limit current flow through LED 270 to a level to provide an extended operational lifetime, and to provide the desired voltage in the Bline signal output. Resistors 272, 273, 274, and 275 have resistances of 5.1 k ohms, 10 k ohms, 200 ohms, and 75 ohms, respectively. The Bline signal output is used as a vocal fader control signal, as will be discussed below in connection with FIG. 7.

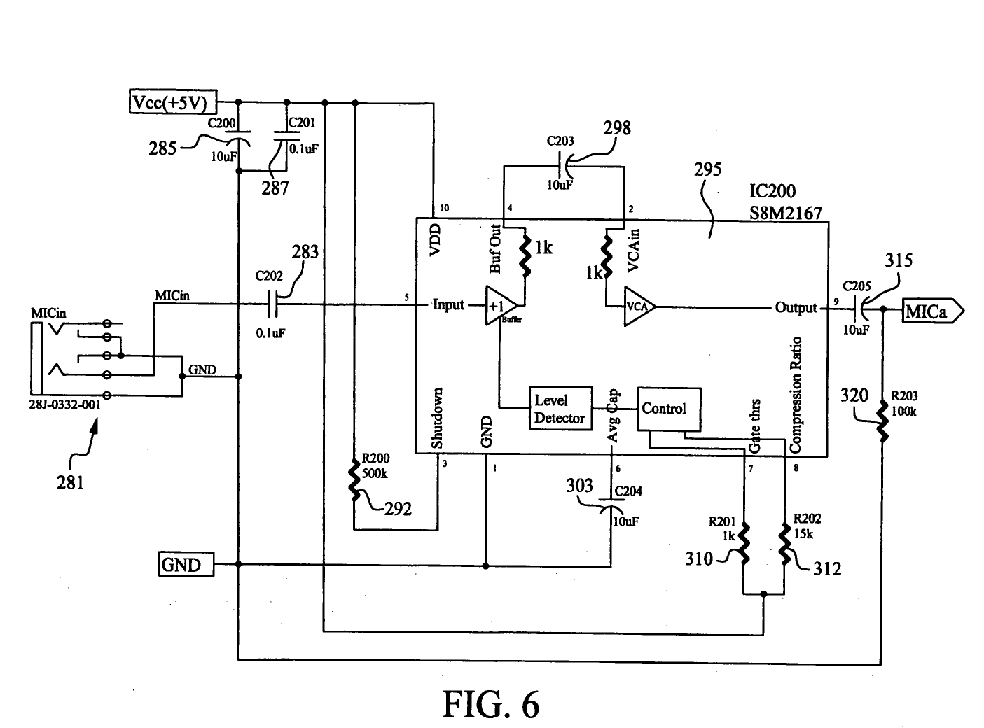

FIG. 6 shows a detailed electrical schematic illustrating circuit portion B of first circuitry 260. An analog input socket for a microphone, such as microphone 102 in FIG. 2, is generally indicated at 281. Socket 281 can be a commercially available 3.5 mm stereo jack to facilitate making device 100 small, e.g. for portability. The microphone input 281 is used to incorporate a user's voice in a Karaoke output from a device 100. The 0.1 micro Farad capacitor 283 desirably is included to decouple any offset signal introduced by the microphone, such as a DC offset, and to pass only the audio portion of a microphone input signal as an input to first circuitry 260.

A 10 micro Farad capacitor 285 and a 0.1 micro Farad capacitor 287 are arranged in-circuit to form a high and low filter circuit operable to remove undesired, or spurious, signal portions in the applied voltage Vcc. This filter combination is provided to enhance sound quality, but is not critical. For example, the formed high and low filters remove any residual or introduced spikes from the power source 267 and 268.

A 500 k ohm resistor 292 is incorporated to limit current applied on pin 3 of the microphone signal processing circuit embodied on integrated circuit chip 295. Integrated circuit chip 295 is operable to modulate and “clean” a signal input through a microphone. Chip 295 is a preamplifier, having variable compression and noise gating operable to reduce background noise and feedback from an audio output resulting from applying the output signal of device 100 through one or more speakers. A voltage input is required on pin 3 of chip 295 to keep the chip in an active state. A low current on pin 3 is desirable to increase life of battery 267, reduce heat loading on chip 295, and enhance a lifespan of the chip. Chip 295 is commercially available from Analog Devices under the designation SSM2167. The 10 micro Farad capacitor 298, between pins 2 and 4, is operable to set a gain for the output of chip 295.

Pin 1 of chip 295 is connected to a ground reference. Pin 10 of chip 295 is the power in pin, and receives the 5 volt signal Vcc. The 10 micro Farad capacitor 303 connected to pin 6 of chip 295 is sized in accordance with the instruction data sheet provided by the chip manufacturer for operation in the vocal range. Capacitor 303 operates as an averaging time constant capacitor to improve signal quality as an automatic level detector in a “true RMS level detector circuit”.

Pins 7 and 8 of chip 295 are connected to 1 k ohm resistor 310 and 15 k ohm resistor 312, respectively. Pin 7 controls a downward expansion threshold to further reduce audibility of input signals of less than −48 decibels. Therefore soft noises are output as even quieter noises in the output signal of a device 100. Resistor 312 connected to pin 8 of chip 295 sets the output gain of ship 295 for a 2:1 amplification ratio in nominal operation. However, the chip operates “on the fly”, attempting to maintain an output signal having an approximately uniform playback volume without unwanted background noises or feedback contamination from a playback device.

An additional signal filtering arrangement desirably is created by capacitor 315 and shunt resistor 320. Capacitor 315 has a value of 10 micro Farads, and shunt resistor 320 has a resistance of 100 k ohms. Capacitor 315 removes any DC offset, and shunt resistor 320 drains any steady-state current, from the microphone signal (designated MICa). Therefore, the MICa output is “cleaned up” in the audio range before it passes further through the first circuitry 260.

FIG. 7 illustrates a music signal input, generally indicated at 325, and an analog main vocal fader 327 portion of circuitry 260. The illustrated music signal input 325 is a socket connector adapted to receive a stereo analog signal from a music source such as a CD player, FM/AM stereo signal, MP3 player, or similar such devices. Alternative circuit arrangements to receive a music signal from an alternative source, such as from an MP3 ripper, or from a hard drive or other nonvolatile memory, are also within contemplation. At least left and right channel information is required to operate a Karaoke device 100.

The 10 micro Farad capacitors 329 and 331 are connected in-circuit to form blocking filters to remove any DC offset in the music input signal. Capacitors 329 and 331 desirably are included to reduce heat loading on vocal fader integrated circuit chip 327. Integrated circuit chip 327 is commercially available from the Rohm Company under the part number BA3838F. The left input music channel is connected to pin 6 of chip 327, and the right music input channel is connected to pin 9 of that integrated circuit chip.

The RC circuit connected to pins 4 and 5 of chip 327 are adapted to maintain the vocal fader integrated circuit chip in the correct mode for a vocal fading operation. The 1 k ohm resistor 337 and the 10 micro Farad capacitor 340 set chip 327 in a mode to ignore a serial input.

Once more, a 10 micro Farad capacitor 345 and a 0.1 micro Farad capacitor 347 are arranged in-circuit to form a high and low filter circuit operable to remove undesired, or spurious, signal portions in the applied voltage Vcc. As with the arrangement illustrated in FIG. 6, this filter combination is provided to remove any residual or introduced spikes in the voltage input Vcc due to the power source 267 and regulator 268.

The voltage signal Vcc is applied to pin 1 and pin 16 of chip 327. Pins 14, 15, and 16 are mode control inputs for chip 327. Pin 14 is connected to ground, and pin 15 receives the BLine signal input (see FIG. 5). Because pin 14 is grounded, an RC circuit is connected to pins 4 and 5 to place chip 327 in a mode to ignore a serial input to pins 6 and 9. The position of switch 265 effects the value of the voltage in the BLine signal, and therefore determines if chip 327 operates in vocal-fader mode, or in play-through mode.

A 22 micro Farad coupling capacitor is connected between ground and pin 8 of chip 327 in accordance with instructions on the data sheet received from the chip manufacturer. Where possible, it is preferred to use electrolytic capacitors to reduce a size of components and the resulting circuit. Therefore, it is important to maintain polarity of the components in a correct orientation when assembling the circuit on a board.

Pins 10, 11, and 12 are time constant inputs for chip 327. A 0.22 micro Farad capacitor 353 is placed in-circuit between pins 11 and 12. Also, a 0.047 micro Farad capacitor 355 is connected between pin 10 and ground. These capacitors determine the characteristics of the notch filter applied to reduce presence of a lead singer's voice in the input signal applied to pins 6 and 9, and output as FDLout at pin 3 and FDRout at pin 13. A typical vocal suppression of the notch filtered portion for the illustrated configuration is about 33 dB, and is set by structure inherent in chip 327. The remainder of the signals (the anti-notch portions) are boosted by 14 dB. The microphone input (MICb applied on pin 2) is boosted by about 8 dB.

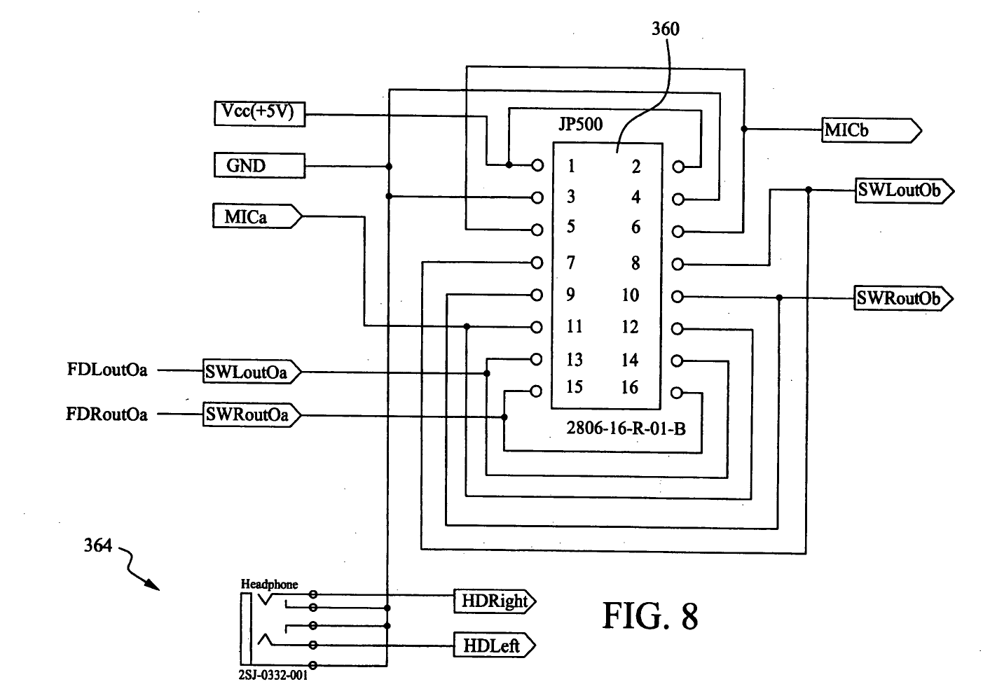

The output signals, FDLout and FDRout from pins 3 and 13 respectively, are passed to the circuit portion illustrated in FIG. 8. When vocal fader integrated circuit chip 327 is placed into play-through mode, the left and right channel information is unfiltered, and the lead singer's voice will remain unchanged in the output signals FDLout and FDRout. In the illustrated circuitry, a microphone input can still be mixed with the output signals, however, so a user could add his voice on top of the original recording and listen in real time, or record the output for later playback. When chip 327 is placed into vocal-fade mode, the left and right channel information is filtered, to reduce the audible presence of the lead singer's voice in the output signals FDLout and FDRout. A user can then sing along, producing a microphone input signal (MICb), and the device 100 will produce a true Karaoke accompaniment. A before, the output can be applied to a playback device, or recorded for future playback, or both.

FIG. 8 illustrates a modular connector 360 and a connector, generally indicated at 364, for attaching device 100 to a playback device, such as headphones or external speaker 104. The connector 364 desirably is a small size socket receptacle, such as a headphone jack commercially available from DigiKey Company under the part number SJ-3515-SMT-1. Playback devices operable with such a socket 364 are ubiquitous, and include headphone sets and loud speaker arrangements.

Modular connector 360 provides in-circuit access to signals for additional or alternative processing, and permits application of additional input signals to the circuitry 260, and extraction of additional output signals from the device 100. Illustrated modular connector 360 is commercially available from the Singatron Company under the part number 2806-16-R-01-B.

Connector 360 provides a plurality of electrical contacts arranged to form an electrical connection with contacts, such as contact 150 in FIG. 1, carried on an expansion, or add-on, card. Connector 360 provides eight pairs of numbered electrical connectors operable to form a current carrying union with cooperating connectors carried on a surface of an add-on card. Flexibility is provided by the connector 360 by taking advantage of the ability to place circuitry contacts on opposite sides of an add-on card. Therefore, an add-on card can carry circuitry that is quite complex.

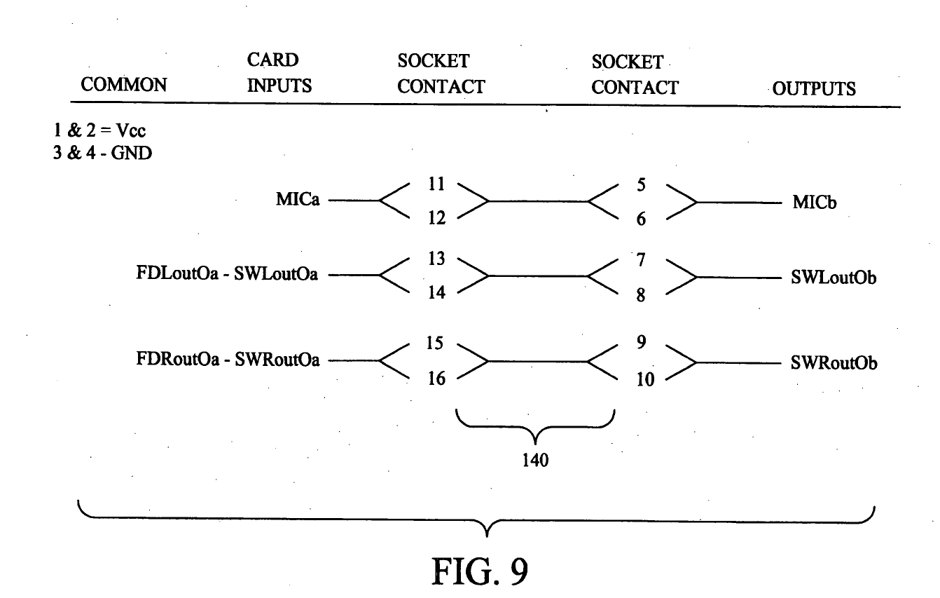

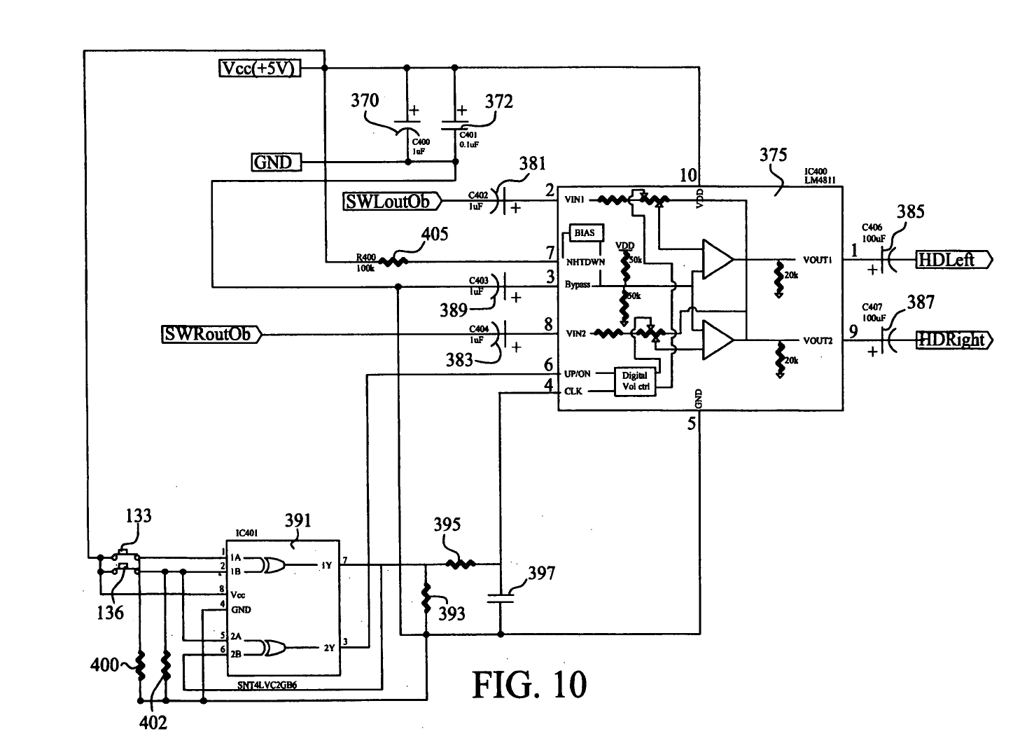

FIGS. 8 and 9 illustrate the wiring arrangement assigned to a modular connector 360 provided on one preferred motherboard used in a Karaoke device 100. As illustrated in FIG. 8, the circuit voltage Vcc is applied to contact 1 of connector 360, and is jumpered to contact 2. A ground GND is applied to contact 3, and jumpered to contact 4. Contacts 5 and 6 of connector 360 are jumpered together, and tied to circuit input MICb. Contacts 7 and 8 of connector 360 are jumpered together, and tied to circuit input SWLoutb. Contacts 9 and 10 of connector 360 are jumpered together, and tied to circuit input SWRoutb. Microphone input MICa is connected to contact 11, and jumpered to contact 12. The vocal fader output signal FDLoutOa is renamed SWLoutOa, and is connected to contact 13 and jumpered to contact 14. The vocal fader output signal FDRoutOa is renamed SWRoutOa, and is connected to contact 15 and jumpered to contact 16. The playback connector 364 receives the inputs HDRight and HDLeft, which are the outputs from the amplifier circuit portion discussed below in connection with FIG. 10.

FIG. 9 illustrates the wiring arrangement of a “placeholder” expansion card 140. Electrically conductive paths are provided on card 140 to form jumpers between contacts 11 and 5; 12 and 6; 13 and 7; 14 and 8; 15 and 9; and 16 and 10. The circuit paths formed on one side of the card 140 could be duplicated on the other side of the card. For example, the circuit path between contact 5 and 11 could be duplicated by a path between contacts 6 and 12. However, the jumper arrangement illustrated in FIG. 8 makes such duplicate paths unnecessary. The ability to access important signals from either side of an add-on card provides flexibility in design of a layout of circuitry carried by the add-on card.

With reference to FIG. 10, a workable amplifier circuit portion effective to output a stereo signal for playback can be described. A power scrubbing filter arrangement can be provided to maintain quality of the applied voltage Vcc. Similar to previously described filter arrangements, power filter circuit can include a 1 micro Farad capacitor 370 and a 0.1 micro Farad capacitor 372 arranged in-circuit to remove undesired signal portions in the applied voltage Vcc. As with the arrangement illustrated in FIGS. 6 and 7, this filter circuit portion desirably is provided to remove any residual or introduced spikes in the voltage input Vcc due to the power source 267 and regulator 268. A tighter filtering range, compared to previously described power filters, is generally set by the capacitance value for capacitor 370 due to the proximity to the amplifier 375. The voltage Vcc is applied to pin number 10 of integrated circuit element 375.

Integrated circuit element 375 is operable as an amplifier effective to change a strength of a signal applied to a playback device As illustrated, amplifier 375 operates to output a stereo signal including left and right channels HDLeft and HDRight, respectively. Integrated circuit chip 375 is commercially available from the National Semiconductor Company under the part number LM4811. The amplifier 375 typically operates as a volume control for the playback device. While the individual circuit elements required for certain functions of first circuitry 260, such as the amplifier portion embodied in chip 375, it is preferred to utilize integrated circuit chips when possible to reduce manufacturing costs and a size of the device 100.

Typically, DC signal blocking filters are connected in-circuit with audio-related inputs and outputs. A 1 micro Farad capacitors 381 is installed in-circuit between the input signal SWLoutOb and pin number 2 of chip 375. Similarly, a 1 micro Farad capacitors 385 is installed in-circuit between the input signal SWRoutOb and pin number 5 of chip 375. A pair of 100 micro Farad capacitors 385 and 387 can be connected in-circuit between output pins 1 and 9 of chip 375 and the playback connector 364 (see FIG. 8). A similar DC blocking filter, formed by 1 micro Farad capacitor 389, desirably is provided to ensure the ground signal GND is steady and clean when connected to pin 3 of chip 375. Pin 3 of chip 375 provides a half-supply voltage reference, which desirably is steady because a drift would effect the chip's op-amp outputs and degrade audio quality.

An output of chip 375 is controlled by a digital input provided by membrane switches 133 and 136, in combination with integrated circuit chip 391. Integrated circuit chip 391 is commercially available from Texas Instruments, Inc. under the part number SN74LVC2G86. A user presses the “up” button 133 to increase a strength of output signals HDLeft and HDRight. Similarly, if a lower volume is desired from a playback device, a user presses and holds down the “down” button 136. The RC circuit formed by resistors 393 and 395 and capacitor 397 sets a clock to provide incremental input to pin 4 of chip 375. The clock frequency is set to a relatively slow rate so that a user can conveniently step through the 16 available levels of output amplification provided by the chip 375. Pull-down resistors 400 and 402 are connected to an output of buttons 133 and 136 to drain any residual current subsequent to button activation, and thereby resist inadvertent input to chip 375.

Additional inputs to chip 375 include input signals SWLoutOb connected to pin 2, and SWRoutOb connected to pin 8. Inputs SWLoutOb and SWRoutOb are routed from the connector 360, if present. If no connector 360 is used, those input signals would come directly from vocal fader chip 327, or alternative vocal fading/processing circuitry. The circuit voltage signal Vcc is connected to pin 10, and through 100 k ohm resistor 405 to pin 7. Resistor 405 reduces a current applied to the chip 375 and is used as an on/off control signal to enable chip operation.

As previously mentioned, additional second circuitry can be placed in-circuit in first circuitry 260 to provide additional processing options, storage for recording, additional inputs for a plurality of singers, and additional outputs for a plurality of headphones. Inputs for add-on cards carrying such second circuitry typically include Vcc from either of contacts 1 or 2 of connector 360; and ground GND from contacts 3 or 4 of expansion slot 360.

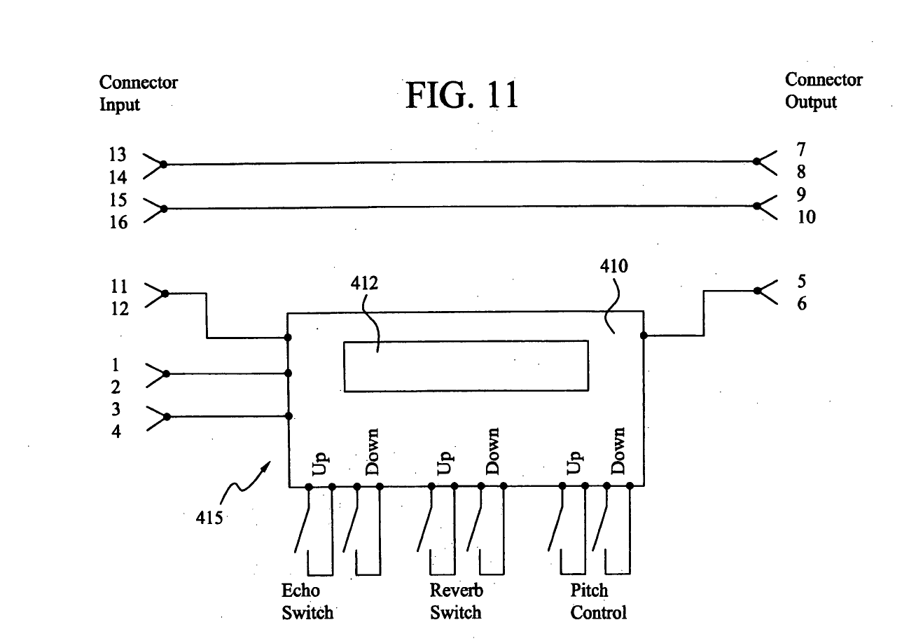

FIG. 11 illustrates an arrangement for a vocal effects add-on card 410 arranged for connection in-circuit in circuitry 260 at connector 360. Card 410 carries circuitry 412 operable to provide desired effects, such as echo, reverb, and pitch control. The microphone input MICa is applied to card 410 from either of contacts 11 or 12 of connector 360. Circuitry operable to produce such vocal effects is known in the art. A plurality of control inputs, generally indicated at 415, are arranged to enable, and modify an amount of, such vocal effects operating on the MICa signal. The modified output signal is then passed to contact 5 or 6 of connector 360.

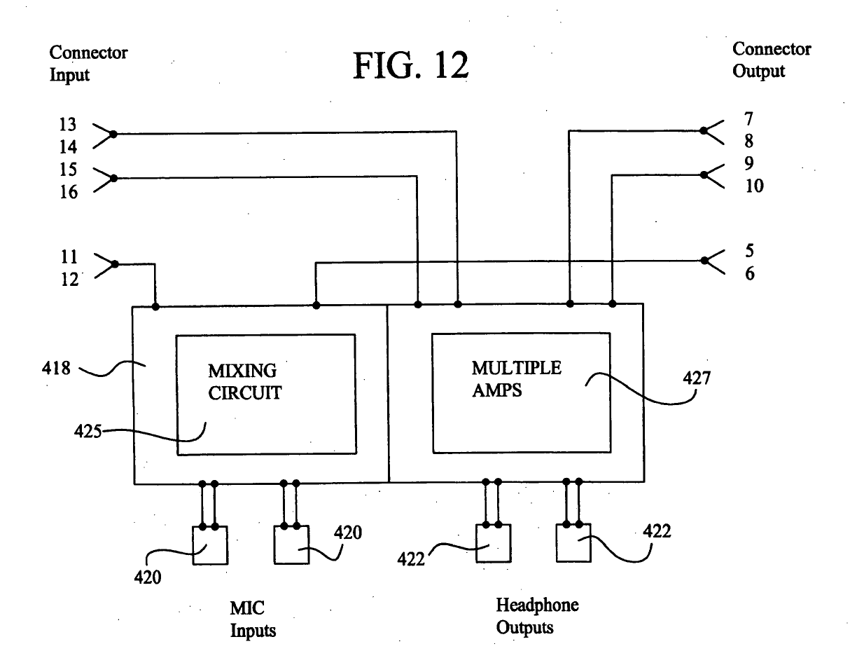

FIG. 12 illustrates a combination add-on card 418 operable to provide one or more additional microphone inputs 420, and one or more additional headphone outputs 422. Of course, it is within contemplation for the add-on card 418 to include only one or more microphone input 420, or one or more headphone output 422. A microphone input card would receive additional microphone input through its one or more microphone jack 420, and pass the acquired microphone input through a preamp and mixing circuit 425, then to vocal fader chip 327 illustrated in FIG. 7, or an equivalent arrangement known in the art. Multiple headphone output can be created by inputting the signals SWLoutOa and SWRoutOa to amplifier circuit 427. In general, a separate volume control and amplifier desirably is provided for each headphone output.

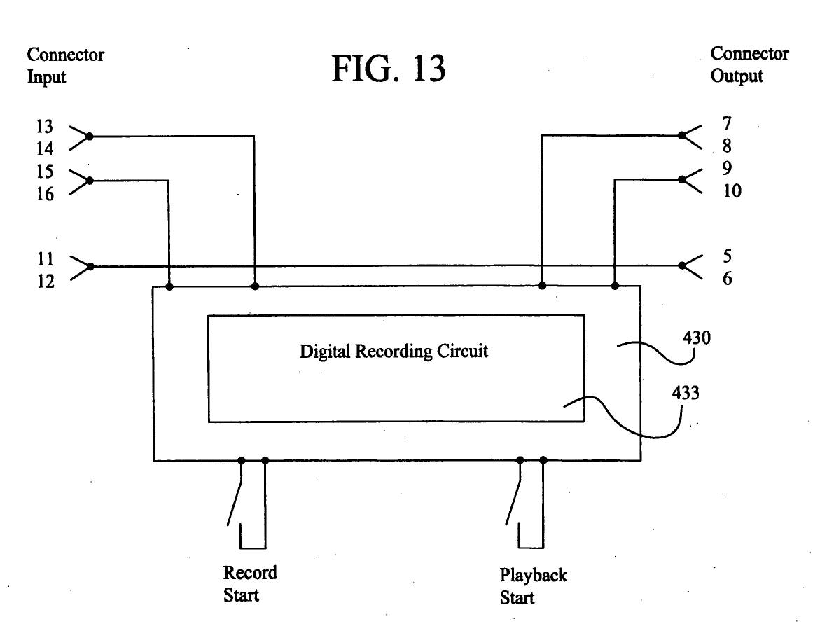

FIG. 13 illustrates an arrangement operable to form a record/playback add-on card 430. An output from a device 100 can include the original input music signal, a user's voice superimposed over unmodified original lead singer's voice, and also vocal faded Karaoke accompaniment, both with or without a user's voice. Card 430 can carry nonvolatile memory conveniently arranged as desired in second circuitry 433. Second circuitry 433 can be arranged according to known principles to permit digital or analog recording. Nonvolatile memory accessed by card 430 can include memory sticks, or chips, to record in a digital format. A daughter card arrangement can be provided on card 430 to permit swapping memory devices, to increase song storage capacity, or for playback of the recorded output on an alternative playback device. Card 430 may also, or additionally, carry connectors, such as one or more of a USB port, serial port, or firewire port, to enable passing the output signal to another storage medium, such as a personal computer. The output signal available for recording will correspond to the mode in which the device 100 is operating, and can include any applied microphone input.

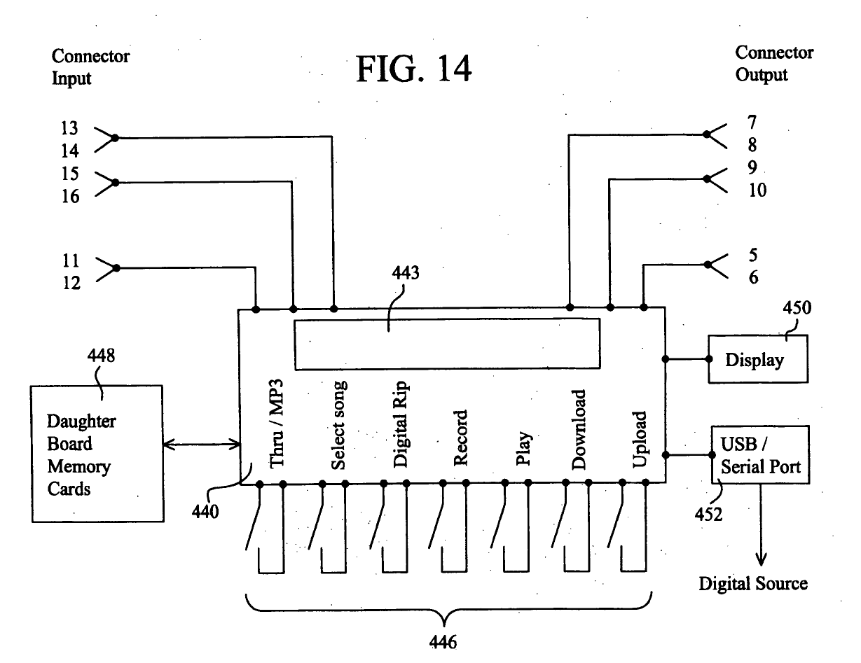

FIG. 14 illustrates an add-on card 440 that is adapted to process a digital music input. Such an input may be in WMA, MP3 or other available digital music format. In certain cases, center channel (or lead singer input) information may be provided as a discrete signal. In any event, card 440 is adapted to operate in a digital mode to process the music input signal. Card 440 can carry A/D converters arranged to convert an input analog music signal into a digital signal, and can include an MP3 ripper in second circuitry 443. Inputs to card 440 include SWLoutOa, SWRoutOa, and MICa from corresponding contacts of expansion slot 360. Control inputs, generally indicated at 446, provide user input for card functions including play-through/MP3, song selection, digital ripping, record, play, download, and upload. A daughterboard 448 or other arrangement, can be provided for storage of an input or output music signal. Sometimes, a display device 450 is provided with card 440 to indicate information to a user, such as: operational status of card 440, lyrics, timing indicators, song number, title or artist information. Again, one or more connectors, such as USB connector 452, can be provided to enhance output options from a device 100.

1. An apparatus for processing a first digital signal that is arranged in a digital music format, and includes information including at least the sound from one vocalist and musical accompaniment, the apparatus comprising:
a source input receptor operable to receive said first digital signal;
a user input receptor operable to receive a user's first microphone input;
a first analog-to-digital converter adapted to operate on said first microphone input and to output a second digital signal;
a first digital processor adapted to operate on said first digital signal to reduce audibility of said vocalist and to output a first-modified digital signal;
a second digital processor arranged in-circuit as a mixer to combine said second digital signal and said first-modified digital signal effective to form a left-out channel, and a right-out channel; and
a digital-to-analog converter adapted to operate on said left-out channel and said right-out channel to form a stereo analog output signal from said apparatus; and
a volume control operable on said stereo analog output signal to effect an audible volume when said stereo analog output signal is applied to a playback device.

2. The apparatus of claim 1, further comprising:
a user operable control effective to select a notch frequency range in which reduction of audibility is performed by said first digital processor.

3. The apparatus of claim 1, further comprising:
a user operable control effective on said first digital processor to select an amount of reduction in audibility of said vocalist.

4. An apparatus for processing a first analog signal that carries information including at least the sound from one vocalist and musical accompaniment in a left channel and a right channel, the apparatus comprising:
a source input receptor operable to receive said first analog signal;
a user input receptor operable to receive a user's analog input;
a first analog-to-digital converter adapted to operate on said first analog signal and to output a first digital signal;
a first signal processor adapted to operate on said first digital signal effective to output information corresponding at least to left-in, right-in, and center-in channels;
a second analog-to-digital converter adapted to operate on said user's analog input and to output a second digital signal;
a second signal processor operable as a reducer and arranged to operate on at least a portion of said center-in channel to reduce audibility of said vocalist and to output a center-out channel;
a third signal processor arranged in-circuit as a mixer to combine said second digital signal, said center-out channel, and said left-in channel to form a left-out channel, and to combine said second digital signal, said center-out channel, and said right-in channel to form a right-out channel; and
a digital-to-analog converter adapted to operate on said left-out and right-out channels to form a stereo analog output signal from said apparatus.

5. The apparatus of claim 4, wherein:
said first signal processor comprises a digital signal processor adapted to output a signal in a digital music format.

6. The apparatus of claim 4, wherein:
said apparatus is embodied in a hand-held device adapted to generate one or more outputs.

7. The apparatus of claim 6, further comprising:
expansion structure adapted to receive an add-on card; and
an add-on card structured for reception in said expansion structure and operable to add a component to an electrical path through said apparatus.

8. The apparatus of claim 7, wherein:
said add-on card comprises a digital signal processor structured and arranged to reduce audibility of said singer's voice.

9. The apparatus of claim 7, wherein:
said add-on card is effective to produce vocal effects in an output.

10. The apparatus of claim 7, wherein:
said add-on card comprises a nonvolatile memory adapted for record and playback of an output signal.

11. The apparatus of claim 7, wherein:
said add-on card comprises a plurality of microphone inputs.

12. The apparatus of claim 7, wherein said add-on card comprises a plurality of headphone outputs.

13. The apparatus of claim 7, wherein:
said add-on card comprises a display device operable to provide a user with visible information.

14. An apparatus for converting a multichannel output signal from a music source, which signal includes an original lead singer's voice and musical accompaniment, into an input that can be applied to a playback device to form audible musical accompaniment for a Karaoke singer, the apparatus comprising:
a first connector adapted to receive said output signal as a first apparatus input signal;
a second connector adapted to receive a second apparatus input signal from a user's first microphone;
first circuitry adapted at a first configuration to:
compare left channel and right channel information carried by said first apparatus input signal and to extract center channel information from said left channel and said right channel to form a first modified left channel, a center channel, and a first modified right channel;
process said center channel effective to reduce audibility of said original lead singer's voice in a resulting processed signal;
mix said second apparatus input signal with said processed signal and said first modified left channel to form a second modified left channel output; and
mix said second apparatus input signal with said processed signal and said first modified right channel to form a second modified right channel output;
an electrical power source adapted to energize said first circuitry;
a third connector adapted to transmit an apparatus output signal, comprising said second modified left channel output and said second modified right channel output, to a playback device; and
a volume control operable on said apparatus output signal to effect an audible volume when said apparatus output signal is applied to said playback device.

15. The apparatus of claim 14, wherein:
said first circuitry comprises an analog vocal fader circuit.

16. The apparatus of claim 14, further comprising a multiway switch comprising:
an off position operable electrically to decouple said power source from said first circuitry;
a play-through position operable to place said first circuitry into a second configuration operable to permit playback of an apparatus output signal comprising said first input signal; and
a first vocal fade position operable to place said first circuitry into said first position.

17. The apparatus of claim 14, further comprising:
an expansion slot comprising a first electrical contact and a second electrical contact, said expansion slot being disposed in-circuit in said first circuitry operably to interrupt a signal between said first electrical contact and said second electrical contact and adapted mechanically and electrically to couple with an add-on card carrying second circuitry; and further in combination with:
an add-on card configured to pass said signal from said first electrical contact to said second electrical contact by way of an electrically conductive path comprising said second circuitry.

18. The apparatus of claim 17, wherein:
said add-on card carries said second circuitry comprising a jumper between said first electrical contact and said second electrical contact.

19. The apparatus of claim 17, wherein:
said add-on card carries said second circuitry comprising a digital processor adaptable to reduce audibility of said original singer's voice.

20. The apparatus of claim 19, wherein:
said digital processor is adapted to operate on data arranged in a conventional digital music format.

21. The apparatus of claim 17, wherein:
said add-on card comprises second circuitry adapted to produce one or more vocal effects.

22. The apparatus of claim 17, wherein:
said add-on card carries second circuitry adapted to record said output signal in a nonvolatile storage media.

23. The apparatus of claim 17, wherein:
said add-on card carries second circuitry comprising a second microphone input to said first circuitry to permit combination of a plurality of user inputs with said processed signal.

24. The apparatus of claim 17, in combination with a first headphone and a second headphone, wherein:
said first headphone is connected to said third connector; and
said add-on card carries second circuitry comprising a fourth connector, adapted to transmit said apparatus output signal, disposed in-circuit with a volume control, for transmission of said apparatus output signal to said second headphone for audible playback.

25. The apparatus of claim 14, wherein:
said apparatus is embodied in a hand-held device.

26. The apparatus of claim 25, wherein:
a size of a height, a width and a thickness of said device is less than about 6 inches, about 4 inches, and about 2 inches, respectively.

27. The apparatus of claim 16, wherein:
said multiway switch further comprises a second vocal fade position operable to configure said apparatus to produce a first output comprising unmodified playback from said music source for audible perception by said user, and a second output comprising said audible musical accompaniment.

28. The apparatus of claim 19, wherein:
said processor is programmable by a user to permit said user to adjust an amount of decibel suppression applied to said lead singer.

29. The apparatus of claim 19, wherein:
said processor is programmable to permit a user to adjust a range of frequencies over which decibel suppression is applied to said lead singer.

30. The apparatus of claim 22, wherein:
said nonvolatile storage media is a memory device carried by said card.

31. The apparatus of claim 17, wherein:
said add-on card comprises a connector adapted to interface with a personal computer.

32. A portable apparatus embodied in a hand-held form factor and operable to output an electric signal that is playable through a playback device to create accompaniment for a Karaoke singer, the apparatus comprising:
a housing adapted to hold a motherboard, carrying first circuitry, and a power source adapted to enable operation of said first circuitry, said housing being arranged to provide external access to one or more connectors comprising a first connector configured to transmit an apparatus output signal and a second connector configured to receive a microphone input; and
a volume control operable to change a strength of said apparatus output signal; wherein:
said first circuitry is operable to process a music input signal from a music source, said music input signal comprising a lead singer and musical accompaniment, to reduce audible presence, when played through said playback device, of said lead singer in said apparatus output signal.

33. The apparatus of claim 32, wherein:
said music source comprise a storage medium carried in said housing.

34. The apparatus of claim 32, wherein:
said apparatus comprises a multiway switch operable on said first circuitry, said switch comprising:
an off position effective electrically to decouple said power source from said first circuitry;
a play-through position effective to place said first circuitry into a second configuration operable to bypass modifications to a presence of lead singer's voice effected by said first circuitry; and
a vocal fade position effective to place said first circuitry in said first position.

35. The apparatus of claim 34, wherein:
said motherboard further comprises an expansion slot disposed in-circuit with said first circuitry and operable to interrupt a signal-carrying path through said first circuit; and in combination with:
an add-on card carrying second circuitry and adapted for operable reception in said expansion slot, said add-on card being configured to pass an electrical signal from a first electrical contact of said expansion slot to a second electrical contact of said expansion slot by way of an extension path comprising said second circuitry.

36. The apparatus of claim 35, wherein:
said add-on card carries said second circuitry comprising a jumper between said first electrical contact and said second electrical contact.

37. The apparatus of claim 35, wherein:
said add-on card carries said second circuitry comprising a digital processor adaptable to reduce audibility of said original singer's voice.

38. The apparatus of claim 35, wherein:
said add-on card carries second circuitry adapted to record said output signal in a nonvolatile storage media.

39. The apparatus of claim 35, wherein:
said add-on card carries second circuitry comprising a second microphone input to said first circuitry to permit combination of a plurality of user inputs with said processed signal.

40. A method for converting an output from a conventional multichannel music source, which output carries information including an original lead singer's voice and musical accompaniment, into substantially real-time musical accompaniment for a Karaoke singer, the process comprising the steps of:
a) providing a Karaoke ripping device;
b) inputting said output from said music source as a first input signal to said device;
c) comparing left channel and right channel information carried by said first input signal to determine a center channel;
d) extracting said center channel from said left channel and said right channel to form a center channel, a modified left channel, and a modified right channel;
e) processing said center channel to reduce audible presence of said original singer's voice in a processed signal; and
f) outputting a combination of said modified left channel, said modified right channel, and said processed signal as an output signal.
